(19) United States
(12) Patent Application Publication
(10) Pub. No.: US 2010/0206153 A1
(43) Pub. Date: Aug. 19, 2010

(54) SPREADER MOUNTING STRUCTURE FOR SAW MACHINE

(75) Inventor: Long-Chang JAN, Changhua County (TW)

Correspondence Address: BROWDY AND NEIMARK, P.L.L.C.;624 NINTH STREET, NW, SUITE 300, WASHINGTON, DC, 20001-5303, US

(73) Assignee: OAV EQUIPMENT 7 TOOLS, INC., Shen Kang Hsiang (TW)

(21) Appl. No.: 12/414,743

(22) Filed: Mar. 31, 2009

(30) Foreign Application Priority Data
Feb. 18, 2009 (TW) 98202362

(51) Int. Cl. B27B 11/02

(52) U.S. Cl. 83/823

(57) ABSTRACT

For use in a saw machine to hold a spreader, a spreader mounting structure is disclosed to include a spreader holder, which has a holder base for fastening to the saw machine, a front bearing wall for bearing an insertion portion of the spreader, a first receiving portion, a holding down device having a shank with a bearing portion insertable through the insertion portion of the spreader into the first receiving portion of the spreader holder and a holding down plate, a control member having an operating portion and an actuation portion movable by the operating portion relative to the bearing portion of the shank of the holding down device to move the holding down plate between a locking position where the holding down plate holds down the insertion portion of the spreader on the front bearing wall of the spreader holder and an unlocking position where the holding down plate is released from the insertion portion of the spreader.

### BACKGROUND OF THE INVENTION

1. Field of the Invention

The present invention relates to a saw machine and more specifically, to a spreader mounting structure for saw machine.

2. Description of the Related Art

A regular saw machine generally has a spreader installed therein to avoid jam of the saw blade in the workpiece during a cutting operation. However, the saw blade of a saw machine may be frequently changed subject to the type of the workpiece to be cut. When a different thickness of saw blade is used, a different thickness of spreader shall be matched. In consequence, different spreader fixation devices are created.

However, conventional spreader fixation devices are commonly of fixed design. The whole assembly must be detached from the table of the saw machine when changing the spreader. There are spreader fixation devices that allow directly dismount of the spreader. However, these spreader fixation devices are commonly have a complicated structure. An improvement in this regard is necessary.

### SUMMARY OF THE INVENTION

The present invention has been accomplished under the circumstances in view. It is the main object of the present invention to provide a spreader mounting structure for saw machine, which holds the spreader positively in position and, allows quick replacement of the spreader.

To achieve this and other objects of the present invention, a spreader mounting structure is provided for fastening to a saw machine to hold a spreader having an insertion portion. The spreader mounting structure comprises a spreader holder, the spreader holder comprising a holder base, a mounting wall for fastening to the saw machine, a front bearing wall for bearing the insertion portion of the spreader, a first receiving portion, and an engagement portion; a holding down device for holding down the insertion portion of the spreader on the front bearing wall of the spreader holder, the holding down device comprising a shank insertable through the insertion portion of the spreader into the first receiving portion of the spreader holder, and a holding down plate fixedly fastened to one end of the shank for holding down the insertion portion of the spreader on the front bearing wall of the spreader holder, the shank comprising a bearing portion; and a control member, the control member comprising a bottom engagement portion for engagement with the engagement portion of the spreader holder, an operating portion, and an actuation portion movable by the operating portion relative to the bearing portion of the shank of the holding down device to move the holding down plate of the holding down device between a locking position where the holding down plate holds down the insertion portion of the spreader on the front bearing wall of the spreader holder and an unlocking position where the holding down plate is released from the insertion portion of the spreader.

Further, the front bearing wall of the spreader holder comprises a chamfered edge for guiding insertion of the insertion portion of the spreader into the spreader holder.

Further, the holder base of the spreader holder comprises two protruding stop flanges disposed at two opposite lateral sides of the front bearing wall and defining with the front bearing wall a recessed space for receiving the insertion portion of the spreader.

Further, the first receiving portion of the spreader holder extends through the front bearing wall.

Further, the holder base of the spreader holder further comprises a second receiving portion, which receives the control member.

Further, the second receiving portion extends across the first receiving portion.

Further, the engagement portion of the spreader holder is a screw hole, and the engagement portion of the control member is a screw rod threaded into the screw hole.

Further, the operating portion of the control member is a tool hole for receiving a tool for rotating the control member.

Further, the moving direction of the bearing portion of the shank of the holding down device is perpendicular to the moving direction of the actuation portion of the control member.

Further, the bearing portion of the shank of the holding down device is tapered through hole, and the actuation portion of the control member is a tapered shank fitting the tapered through hole of the bearing portion of the holding down device.

Further, the spreader comprises a notch located on the insertion portion.

Further, the shank of the holding down device comprises a shoulder; the spreader mounting structure further comprises a spring member sleeved onto the shank of the holding down device and stopped between the shoulder of the shank of the holding down device and a part of the spreader holder.

Further, the spreader holder further comprises a back cover covered on a back side of the spreader holder and stopped at one end of the spring member against the shoulder of the shank of the holding down device.

Further, the shank of the holding down device comprises an extension rod inserted through the spring member to hold the spring member between the shoulder of the shank of the holding down device and a part of the spreader holder.

### BRIEF DESCRIPTION OF THE DRAWINGS

FIG. 1 is an elevational assembly view of a spreader mounting structure in accordance with the present invention.

FIG. 2 is an exploded view of the spreader mounting structure in accordance with the present invention.

FIG. 3 is a sectional view taken along line 3-3 of FIG. 1.

### DETAILED DESCRIPTION OF THE INVENTION

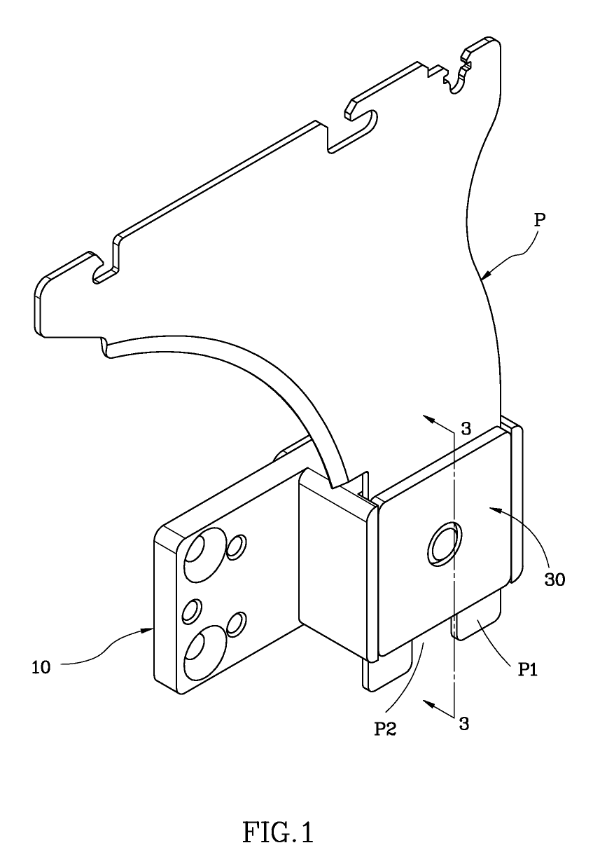

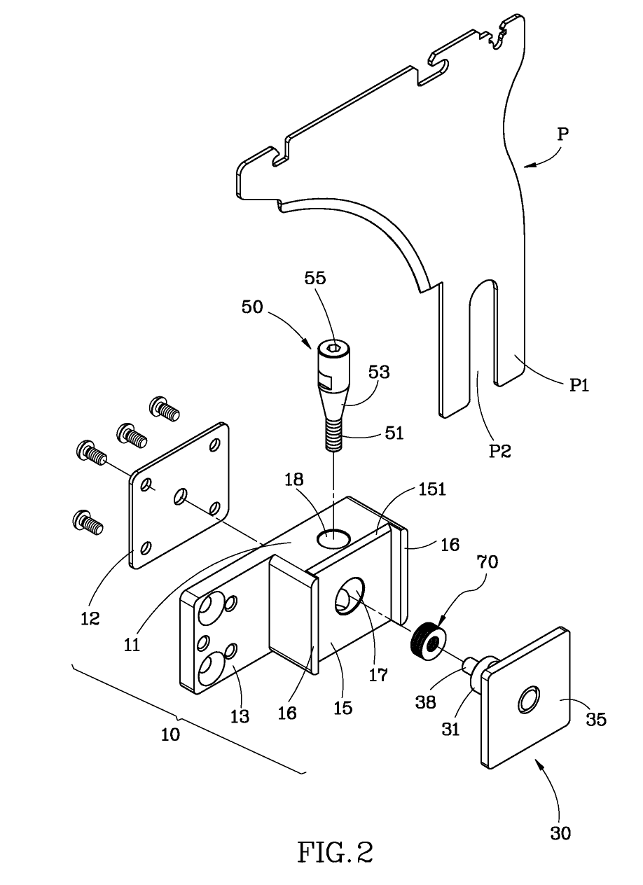

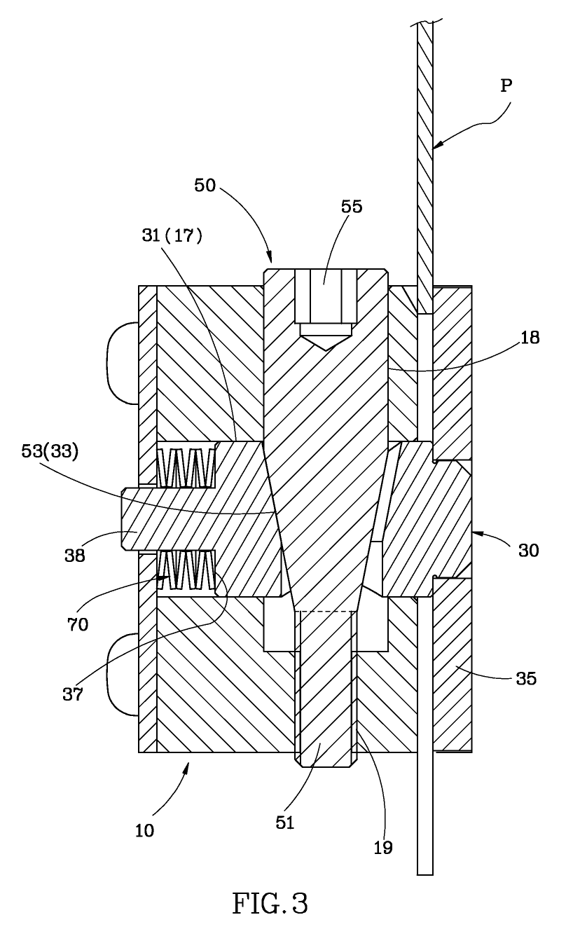

Referring to FIGS. 1-3, a spreader mounting structure in accordance with the present invention is adapted for fastening to a saw machine to hold a spreader P firmly in position. The spreader P has an insertion portion P1 and a notch P2 on the insertion portion P1. The spreader mounting structure comprises a spreader holder 10, a holding down device 30, a control member 50, and a spring member 70.

The spreader holder 10 comprises a holder base 11, a back cover 12 covered on the back side of the holder base 11, and a mounting wall 13 formed integral with the holder base 11 for fastening to a saw machine. The holder base 11 has a front bearing wall 15, a chamfered edge 151 located on the top side of the front bearing wall 15, two protruding stop flanges 16 disposed at two opposite lateral sides of the front bearing wall 15 and defining with the front bearing wall 15 a recessed space for receiving the insertion portion P1 of the spreader P, a first receiving portion 17 extending through the front bearing wall 15, a second receiving portion 18 extending across the first receiving portion 17, and an engagement portion 19 located on one end of the second receiving portion 18. According to this embodiment, the engagement portion 19 is a screw hole.

The holding down device 30 comprises a shank 31 insertable through the notch P2 of the spreader P into the first receiving portion 18 of the spreader holder 10, and a holding down plate 35 fixedly fastened to one end of the shank 31 for holding down the insertion portion P1 of the spreader P on the front bearing wall 15 of the spreader holder 10. The shank 31 has one end perpendicularly fixedly connected to the holding down plate 35, an opposite end terminating in an extension rod 38, a bearing portion 33, which, according to the present preferred embodiment is a tapered through hole transversely cut through the shank 31, and a shoulder 37 disposed between the extension rod 38 and the bearing portion 33.

The control member 50 is mounted in the second receiving portion 18 of the spreader holder 10, having a bottom engagement portion 51, which, according to the present preferred embodiment is a screw rod, a top operating portion 55, which, according to the present preferred embodiment, is a tool hole operable with a tool to rotate the control member 50, and a middle actuation portion 53, which, according to the present preferred embodiment is a tapered shank fitting the bearing portion 33 (tapered through hole) of the holding down device 30.

Further, the moving direction of the bearing portion 33 (tapered through hole) of the holding down device 30 is perpendicular to the moving direction of the middle actuation portion 53 of the control member 50.

The spring member 70 is sleeved onto the extension rod 38 of the shank 31 of the holding down device 30 and stopped between the bearing portion 33 of the shank 31 of the holding down device 30 and the back cover 12.

The operation and functioning of the spreader mounting structure are outlined hereinafter.

Drive the operating portion 55 to rotate the control member 50 in moving the bottom engagement portion (screw rod) 51 of the control member 50 upwards relative to the engagement portion (screw hole) 19 and simultaneously lifting the actuation portion (tapered shank) 53 of the control member 50 from the bearing portion (tapered through hole) 33 of the holding down device 30 for enabling the spring member 70 to push the holding down device 30 outwards relative to the holder base 11 of the spreader holder 10 so that the holding down plate 35 is moved apart from the insertion portion P1 of the spreader P. At this time, the user can insert the spreader P into the recessed receiving space defined between two protruding stop flanges 16 of the spreader holder 10 and between the front bearing wall 15 of the holder base 11 and the holding down plate 35 of the holding down device 30. Thereafter, drive the operating portion 55 to rotate the control member 50 in moving the bottom engagement portion (screw rod) 51 of the control member 50 downwards relative to the engagement portion (screw hole) 19 and simultaneously lowering the actuation portion (tapered shank) 53 of the control member 50 in the bearing portion (tapered through hole) 33 of the holding down device 30 for enabling the spring member 70 to push the holding down device 30 inwards relative to the holder base 11 of the spreader holder 10 so that the holding down plate 35 is moved toward the holder base 11 to hold down the insertion portion P1 of the spreader P on the front bearing wall 15 of the holder base 11.

On the contrary, when detaching the spreader P, reverse the aforesaid operating procedure. Thus, it is quite simple to mount and dismount the spreader P.

Subject to the aforesaid structural features, the invention has the following advantages:

The chamfered edge 151 of the front bearing wall 15 of the holder base 11 facilitates insertion of the insertion portion P1 of the spreader P into the spreader holder 10 in position, and the two protruding stop flanges 16 of the spreader holder 10 prohibit the spreader P from biasing. Therefore, the invention allows easy and rapid mounting and dismounting of the spreader P, and assures a high level of installation safety.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A spreader mounting structure for fastening to a saw machine to hold a spreader having an insertion portion, the spreader mounting structure comprising:
a spreader holder, said spreader holder comprising a holder base, a mounting wall for fastening to the saw machine, a front bearing wall for bearing the insertion portion of the spreader, a first receiving portion, and an engagement portion;
a holding down device for holding down the insertion portion of the spreader on the front bearing wall of said spreader holder, said holding down device comprising a shank insertable through the insertion portion of the spreader into the first receiving portion of the spreader holder, and a holding down plate fixedly fastened to one end of said shank for holding down the insertion portion of the spreader on the front bearing wall of the spreader holder, said shank comprising a bearing portion; and
a control member, said control member comprising a bottom engagement portion for engagement with the engagement portion of the spreader holder, an operating portion, and an actuation portion movable by said operating portion relative to the bearing portion of said shank of the holding down device to move the holding down plate of said holding down device between a locking position where said holding down plate holds down the insertion portion of the spreader on the front bearing wall of the spreader holder and an unlocking position where said holding down plate is released from the insertion portion of the spreader.

2. The spreader mounting structure as claimed in claim 1, wherein the holder base of said spreader holder further comprises two protruding stop flanges disposed at two opposite lateral sides of said front bearing wall and defining with said front bearing wall a recessed space for receiving the insertion portion of the spreader.

3. The spreader mounting structure as claimed in claim 2, wherein the front bearing wall of said spreader holder comprises a chamfered edge for guiding insertion of the insertion portion of the spreader into said spreader holder.

4. The spreader mounting structure as claimed in claim 2, wherein the holder base of said spreader holder further comprises a second receiving portion, which receives said control member.

5. The spreader mounting structure as claimed in claim 4, wherein said second receiving portion extends across said first receiving portion.

6. The spreader mounting structure as claimed in claim 5, wherein the first receiving portion of said spreader holder extends through said front bearing wall.

7. The spreader mounting structure as claimed in claim 1, wherein the holder base of said spreader holder further comprises a second receiving portion, which receives said control member.

8. The spreader mounting structure as claimed in claim 7, wherein said second receiving portion extends across said first receiving portion.

9. The spreader mounting structure as claimed in claim 8, wherein the shank of said holding down device comprises a shoulder; the spreader mounting structure further comprises a spring member sleeved onto the shank of said holding down device and stopped between the shoulder of said shank of the holding down device and a part of said spreader holder.

10. The spreader mounting structure as claimed in claim 9, wherein the shank of said holding down device comprises an extension rod inserted through said spring member to hold said spring member between the shoulder of said shank of the holding down device and a part of said spreader holder.

11. The spreader mounting structure as claimed in claim 10, wherein said spreader holder further comprises a back cover covered on a back side of said spreader holder and stopped at one end of said spring member against the shoulder of said shank of the holding down device.

12. The spreader mounting structure as claimed in claim 8, wherein the moving direction of said bearing portion of the shank of said holding down device is perpendicular to the moving direction of said actuation portion of the control member.

13. The spreader mounting structure as claimed in claim 12, wherein the bearing portion of said shank of the holding down device is tapered through hole; the actuation portion of said control member is a tapered shank fitting the tapered through hole of said bearing portion of the holding down device.

14. The spreader mounting structure as claimed in claim 13, wherein the engagement portion of said spreader holder is a screw hole, and the engagement portion of said control member is a screw rod threaded into said screw hole.

15. The spreader mounting structure as claimed in claim 14, wherein the operating portion of said control member is a tool hole for receiving a tool for rotating said control member.

16. The spreader mounting structure as claimed in claim 8, wherein the bearing portion of said shank of the holding down device is tapered through hole; the actuation portion of said control member is a tapered shank fitting the tapered through hole of said bearing portion of the holding down device.

17. The spreader mounting structure as claimed in claim 16, wherein the engagement portion of said spreader holder is a screw hole, and the engagement portion of said control member is a screw rod threaded into said screw hole.

18. The spreader mounting structure as claimed in claim 17, wherein the operating portion of said control member is a tool hole for receiving a tool for rotating said control member.

19. The spreader mounting structure as claimed in claim 8, wherein the engagement portion of said spreader holder is a screw hole, and the engagement portion of said control member is a screw rod threaded into said screw hole.

20. The spreader mounting structure as claimed in claim 8, wherein the first receiving portion of said spreader holder extends through said front bearing wall.
